(19) United States
(12) Patent Application Publication
(10) Pub. No.: US 2019/0030467 A1
(43) Pub. Date: Jan. 31, 2019

(54) SPRAYER INLET FILTER AND METHOD

(71) Applicant: Scott Merritt, Worchester, MA (US)

(72) Inventor: Scott Merritt, Worchester, MA (US)

(21) Appl. No.: 16/051,318

(22) Filed: Jul. 31, 2018

Related U.S. Application Data
(60) Provisional application No. 62/605,067, filed on Jul. 31, 2017.

(51) Int. Cl. B01D 29/19; B01D 29/90; B01D 29/00

(52) U.S. Cl. CPC B01D 29/19; B01D 2201/32; B01D 29/0011; B01D 29/902

(57) ABSTRACT

An inlet filter is usable on a sprayer, such as a gravity-feed paint sprayer. The inlet filter can include a lip for placement on the top of the sprayer's hopper and a mesh screen for filtering a spray liquid medium, such as paint, as it is poured directly from its container into the hopper. The inlet filter removes the need for a paper filter, filter stand and transfer cup as is conventionally used in paint filtering operations.

### CROSS-REFERENCE TO RELATED APPLICATIONS

This application claims the benefit of priority of U.S. provisional patent application No. 62/605,067, filed Jul. 31, 2017, the contents of which are herein incorporated by reference.

### BACKGROUND OF THE INVENTION

### 1. Field of the Invention

Embodiments of the invention relates generally to spraying apparatus and accessories. More particularly, the invention relates to a sprayer inlet filter and methods for using the same.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The gravity feed spray gun is well known for automotive painting, carpentry painting and a variety of other home and industrial coating applications. The gravity feed spray gun provides optimal atomization and particle size of paint or coatings for an even spray.

Referring to FIG. 1, the current equipment for filling and filtering the paint into the gun involves use of a paper filter 102 that is both prone to spilling and is inefficient in operation. Typically, the use of a paper filter 102 further involves the use of a filter stand 100 and a separate cup 104 for collection of the paint prior to transfer into the spray gun. These conventional methods take time, require additional materials and end up in loss of paint due to coating of the filter 102 and the cup 104.

In view of the foregoing, there is a need for a device and method that can streamline and improve the efficiency of the filling and filtering of paint being transferred into a sprayer.

### SUMMARY OF THE INVENTION

Embodiments of the present invention provide a method for filtering a spray liquid medium, comprising positioning an inlet filter over a hopper of a sprayer, the inlet filter having an outer ring forming a flattened lip, a side wall extending downward into the hopper, and a mesh forming a bottom surface of the inlet filter; and pouring spray liquid medium from a container into the inlet filter, through the mesh and into the hopper, wherein the mesh filters the spray liquid medium poured therethrough.

Embodiments of the present invention further provide a spraying system comprising a sprayer; and an inlet filter having an outer ring forming a flattened lip, a side wall extending downward into the hopper, and a mesh forming a bottom surface of the inlet filter.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a conventional method for filtering paint for a sprayer;

FIG. 2 illustrates a top view of an inlet filter according to an exemplary embodiment of the present invention;

FIG. 3 illustrates a bottom perspective view of the inlet filter of FIG. 2;

FIG. 4 illustrates a cross-sectional view of an inlet filter according to an exemplary embodiment of the present invention;

FIG. 5 illustrates placement of the inlet filter of FIG. 2 onto a sprayer, according to an exemplary embodiment of the present invention;

FIG. 6 illustrates the inlet filter of FIG. 2 disposed on the sprayer;

FIG. 7 illustrates the inlet filter of FIG. 2 with a threaded ring for permitting removal and exchange of the mesh, according to an exemplary embodiment of the present invention; and

FIG. 8 illustrates a cross-sectional view illustrating an internal and external configuration according to an exemplary embodiment of the present invention.

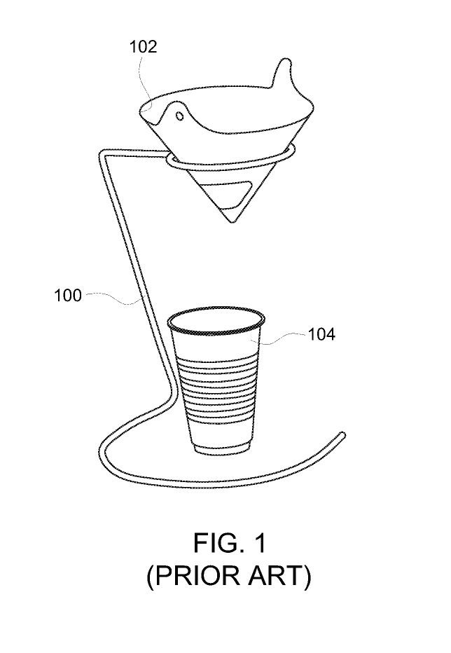

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an inlet filter usable on a sprayer, such as a gravity-feed paint sprayer. The inlet filter can include a lip for placement on the top of the sprayer's hopper and a mesh screen for filtering a spray liquid medium, such as paint, as it is poured directly from its container into the hopper. The inlet filter removes the need for a paper filter, filter stand and transfer cup as is conventionally used in paint filtering operations. Moreover, the inlet filter eliminates cross-contamination that may occur in conventional systems due to their use of a cup for transferring filtered material.

As used herein, the term “sprayer” or “paint sprayer” may refer to an apparatus for application of paint or other spray liquid medium onto a surface. Sprayers can include gravity-fed sprayers such as suction-style sprayers, high velocity low pressure (HVLP) sprayers, low velocity low pressure (LVLP) sprayers, or the like.

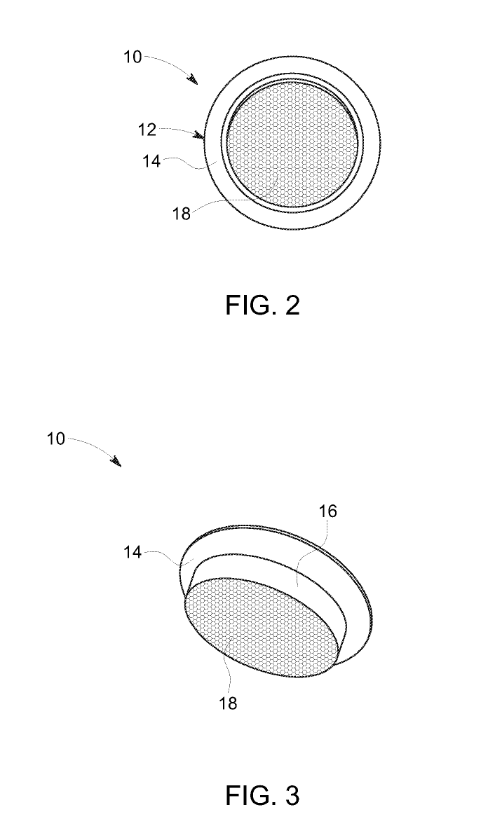

Referring to FIGS. 2 through 4, an inlet filter 10 can include an outer ring 12 that may be substantially flattened to form a lip 14. A side wall 16 may extend downward, away from the lip 14. In some embodiments, the side wall 16 may extend from an inside periphery of the outer ring 12. In some embodiment, the side wall 16 may extend in a direction substantially orthogonal to the lip 14. In some embodiments, the side wall 16 may be angled inward, such that a diameter formed from a top end of the side wall 16 is greater than a diameter formed from a bottom end of the side wall 16. Such a frusto-conical shape may be useful for fitting the inlet filter into a hopper of a sprayer, as described below.

The lip 14 may be sized to be larger than the diameter of the hopper in which it is to be used. In some embodiments, the lip 14 may be angled toward an interior of the inlet filter 10, where any paint or other spray liquid medium poured onto the lip 14 can be urged into the inlet filter 10. In some embodiments, the lip 14 may be oversized, or a lip extender may be used to create a larger lip. Such a lip extender may be a large flattened ring, similar to a washer having an inside hole configured to receive the side wall 16 of the filter 10 therein, or may be a funnel shaped structure, or the like.

A mesh 18 may be formed at the bottom of the side wall 16. In some embodiments, the side wall 16 may be formed of the same material as the mesh 18. In other embodiments, the side wall 16 may be formed from a solid material, typically the same material that forms the outer ring 12 and lip 14.

The mesh 18 may be configured for filtering a spray liquid medium, such as paint, that is poured therethrough. In some embodiments, the mesh 18 may be a stainless steel mesh material. In other embodiments, the mesh 18 may be formed from other materials, such as plastics, metal, composite or the like. The mesh 18 may be attached to the side wall 16 via various methods, such as laser welding, or the like. In some embodiments, depending on the specific materials and design, the mesh may be attached via a glue or formed integrally with the sides, for example.

The mesh 18 may be formed in various mesh sizes, depending on the particular application and requirements of the user.

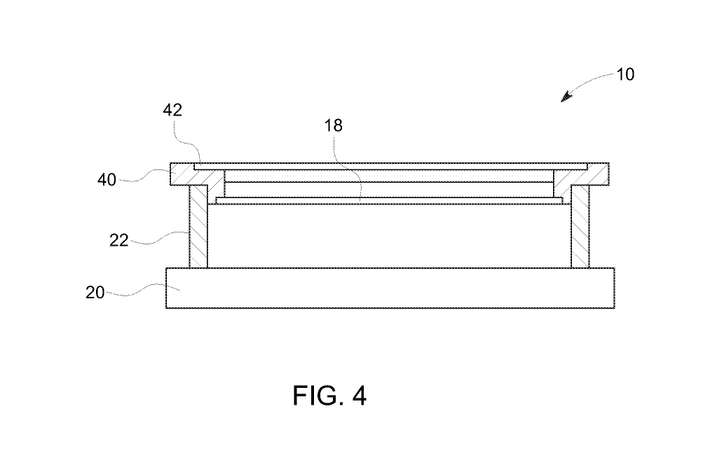

In some embodiments, such as that shown in FIG. 4, the outer ring 12 may include a upward turned outer portion 40 that can permit a cover 42 to be placed and secured therein. The cover 42 may be flat, as shown, or may include a handle or other protrusion for facilitating removal or placement thereof.

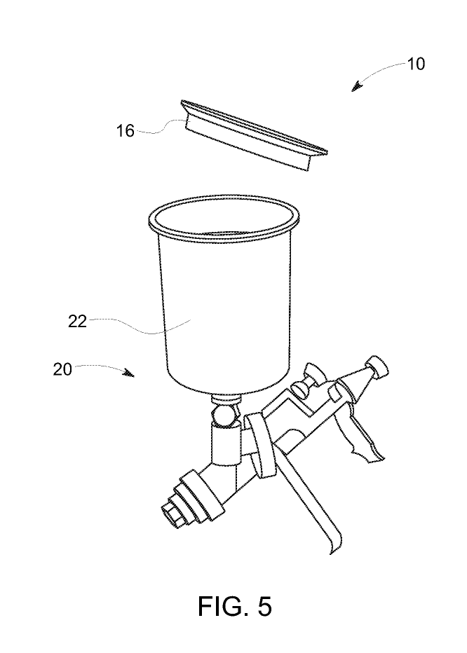

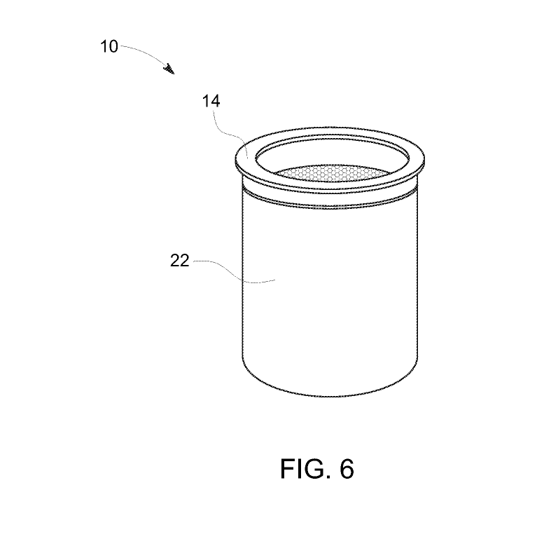

Referring to FIGS. 5 and 6, the spray liquid medium, such as paint, may be poured through the inlet filter 10 into a hopper 22 of a gravity fed sprayer 20. Once paint transfer is complete, the user may remove the inlet filter 10, cover the hopper 22, as required by the particular operation requirements of the sprayer 20, and deliver paint from the sprayer 20. The inlet filter 10 may be easily cleaned after use and reused as needed. In some embodiments, the inlet filter 10 may be stored on top of the hopper 22 to permit immediate reuse as may be desired. Typically, the lip 14 is sized to fit on top of the hopper 22, as shown. However, in some embodiments, the outer ring 12 may be sized to frictionally fit inside the hopper 22.

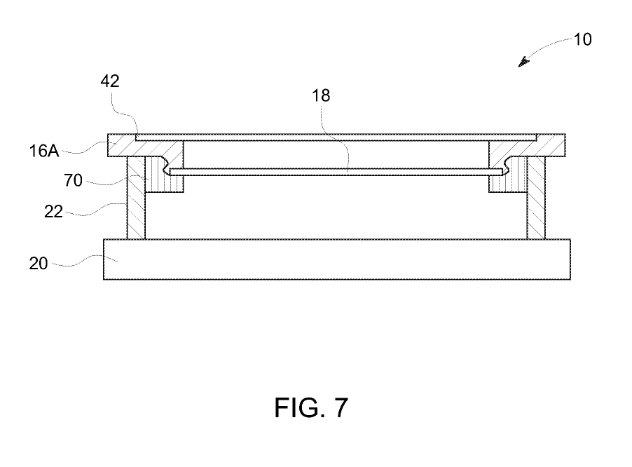

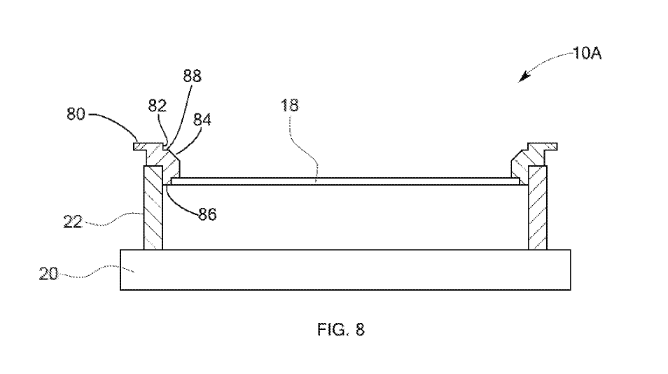

Referring to FIG. 7, the inlet filter 10A may have side wall 16A that includes threads on at least a portion of its outer periphery thereof. The threads can allow the mesh 18 to be either removed for cleaning or for substitution by a filter with different size mesh, for example. A female threaded ring 70 may be disposed onto the outside of the side wall 16A for receiving the male threads of the side wall 16A and retain the mesh 18 into its desired position.

Referring to FIG. 8, in some embodiments, a filter 10C can include a shape permitting stackable storage thereof. In this embodiment, an outside diameter of the side wall 86 may not only fit into the hopper 22, but also is sized to be slightly less than an inside diameter defined by vertical wall 82. An internal step 88 may be formed to receive a bottom of the side wall 86 when the filters 10C are stacked on top of each other. A sloped surface 84 may optionally connect the internal step 88 to an inside of the side wall 86, thereby permitting spilled spray liquid medium to move toward the mesh 18. The filter 10C can include an outer ring 80, similar to that described above.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for filtering a spray liquid medium, comprising:
positioning an inlet filter over a hopper of a sprayer, the inlet filter having an outer ring forming a flattened lip, a side wall extending downward into the hopper, and a mesh forming a bottom surface of the inlet filter; and
pouring the spray liquid medium from a container into the inlet filter, through the mesh and into the hopper, wherein the mesh filters the spray liquid medium poured therethrough.

2. The method of claim 1, further comprising removing the inlet filter after use.

3. The method of claim 2, further comprising cleaning the inlet filter to permit reuse thereof.

4. The method of claim 1, wherein the side wall frictionally fits into the hopper.

5. The method of claim 1, wherein an outer diameter of the lip is greater than an outer diameter of the hopper.

6. The method of claim 1, wherein an outer surface of the side walls includes threads for engagement with a mesh retention member configured to removably dispose the mesh at the bottom of the inlet filter.

7. The method of claim 1, wherein the inlet filter is formed from a material selected from one or more of plastic, metal and composite.

8. The method of claim 8, wherein the metal is stainless steel.

9. The method of claim 1, wherein the side walls are sized to stack into an internal step formed in the flattened lip.

10. A spraying system comprising:
a sprayer; and
an inlet filter having an outer ring forming a flattened lip, a side wall extending downward into a hopper, and a mesh forming a bottom surface of the inlet filter.

11. The spraying system of claim 10, wherein an outer diameter of the lip is greater than an outer diameter of the hopper.

12. The paint spraying system of claim 10, wherein the inlet filter is formed from a material selected from one or more of plastic, metal and composite.

13. The paint spraying system of claim 12, wherein the metal is stainless steel.

14. The paint spraying system of claim 10, wherein the inlet filter includes an internal step sized to receive an outside diameter of the side walls therein when one of the inlet filters is stacked on a second one of the inlet filters.

15. The spraying system of claim 14, further comprising a sloped region connection an internal bottom of the internal step to an internal top of the side walls.
